(19) United States
(12) Patent Application Publication
(10) Pub. No.: US 2025/0298403 A1
(43) Pub. Date: Sep. 25, 2025

(54) PROGRESS MANAGEMENT SYSTEM, PRODUCTION EXECUTION SYSTEM, AND PROGRESS MANAGEMENT METHOD

(71) Applicant: Hitachi, Ltd., Tokyo (JP)

(72) Inventors: Kohei MIYATA, Tokyo (JP); Norisuke FUJII, Tokyo (JP); Yuuichi SUGINISHI, Tokyo (JP)

(21) Appl. No.: 18/861,699

(22) PCT Filed: Apr. 4, 2023
(86) PCT No.: PCT/JP2023/013926

§ 371 Date: Oct. 30, 2024

(30) Foreign Application Priority Data
Aug. 25, 2022 (JP) 2022-134279

(51) Int. Cl. G05B 19/418

(52) U.S. Cl. CPC G05B 19/41865; G05B 19/4184

(57) ABSTRACT

A progress management system has a control unit and a storage unit, which holds a production plan for one or more products. The production plan includes, for the operation of each process for producing each of the products: the allocation of the operation of the process to equipment; scheduled start and end times for the operation of the process; and a scheduled end time for the operation of the process. The control unit predicts, on the basis of the production plan, productivity for the case in which the operation of the process is delayed, and, on the basis of the delay amount of the operation of the process for the case in which it is predicted that the productivity will not satisfy a predetermined standard. The control unit generates a changing proposal for the production plan and a switching timing to the changing proposal for the production plan such.

### INCORPORATION BY REFERENCE

The present application claims priority from Japanese Patent Application No. 2022-134279, filed on Aug. 25, 2022, the content of which is incorporated by reference herein.

### TECHNICAL FIELD

The invention relates to a technique for managing the progress of production.

### BACKGROUND ART

As a technique for managing the progress of a project, for example, a technique described in Japanese Unexamined Patent Application Publication No. Hei 8 (1996)-202773 (Patent Literature 1) is disclosed. Patent Literature 1 describes: “An operator monitoring unit notifies the progress status of an operator to a project plan creation device. A progress control unit instructs a delay alarm and an execution prioritization operation to the operator on the basis of the progress status of the operator. A product manhour estimation unit estimates the manhour of a product made in each process on the basis of the product by triggering the progress status from the operator monitoring unit. An operation allocation unit and an operator allocation unit allocate an activity to a group or the operator on the basis of the manhour of each product calculated by the product manhour estimation unit, and create a project plan.”.

### CITATION LIST

### Patent Literature

Patent Literature 1: Japanese Unexamined Patent Application Publication No. Hei 8(1996)-202773

### SUMMARY OF INVENTION

### Technical Problem

According to the technique described in Patent Literature 1, the manhour can be estimated on the basis of the progress of the process, and on the basis of that, the completion date and time can be predicted. On the basis of the prediction of the completion date and time, the presence or absence of the influence on the productivity according to the progress status of the process is estimated. Then, the allocation of the resource such as the operator to the process is performed on the basis of the progress status, thereby creating the project plan.

However, the completion date and time cannot be predicted on the basis of the actual progress status unless the process progresses to some extent, and for example, even when at the point of time of acquiring the prediction result that the influence on the productivity such as the delivery date delay will occur, the subsequent project plan is reviewed, there is a case where a plan so as to avoid the delivery date delay with the remaining time cannot be made since a certain degree of time has already elapsed at that point in time.

### Solution to Problem

In order to solve at least one of the above problems, the present invention provides a progress management system, and the progress management system includes: a control unit; and a storage unit. The storage unit holds a production plan for one or more products, the production plan includes, for the operation of each process for producing each of the products: the allocation of the operation of the process to equipment; a scheduled start time for the operation of the process; and a scheduled end time for the operation of the process, the control unit predicts, on the basis of the production plan, productivity for the case in which the operation of the process is delayed, and, on the basis of the delay amount of the operation of the process for the case in which it is predicted that the productivity will not satisfy a predetermined standard, the control unit generates a changing proposal for the production plan and a switching timing to the changing proposal for the production plan such that the productivity satisfies the predetermined standard when the delay of the delay amount occurs in the operation of the process.

### Advantageous Effects of Invention

According to an aspect of the invention, even when the delay of the process occurs, the productivity can be prevented from being lowered.

Objects, configurations, and effects other than the above will be apparent from the description of the following embodiments.

### BRIEF DESCRIPTION OF DRAWINGS

FIG. 1 is a block diagram illustrating the configuration of a production execution system according to an embodiment of the invention;

FIG. 2A is an explanatory view illustrating the outline of progress management by the production execution system according to the embodiment of the invention;

FIG. 2B is an explanatory view illustrating the outline of progress management by the production execution system according to the embodiment of the invention;

FIG. 2C is an explanatory view illustrating the outline of progress management by the production execution system according to the embodiment of the invention;

FIG. 3 is an explanatory view illustrating the outline of the entire production execution by the production execution system according to the embodiment of the invention;

FIG. 4A is an explanatory view illustrating article master information held by a scheduling master information storage unit of a progress management system according to the embodiment of the invention;

FIG. 4B is an explanatory view illustrating process master information held by the scheduling master information storage unit of the progress management system according to the embodiment of the invention;

FIG. 4C is an explanatory view illustrating process order master information held by the scheduling master information storage unit of the progress management system according to the embodiment of the invention;

FIG. 4D is an explanatory view illustrating equipment master information held by the scheduling master information storage unit of the progress management system according to the embodiment of the invention;

FIG. 4E is an explanatory view illustrating equipment allocation master information held by the scheduling master information storage unit of the progress management system according to the embodiment of the invention;

FIG. 5 is an explanatory view illustrating production plan information held by a production plan storage unit of the progress management system according to the embodiment of the invention;

FIG. 6 is an explanatory view illustrating production result information held by a production result storage unit of the progress management system according to the embodiment of the invention;

FIG. 7 is an explanatory view illustrating production preparation manhour information held by a production preparation manhour storage unit of the progress management system according to the embodiment of the invention;

FIG. 8A is an explanatory view illustrating switching timing information held by a rescheduling proposal and switching timing storage unit of the progress management system according to the embodiment of the invention;

FIG. 8B is an explanatory view illustrating rescheduling proposal information held by the rescheduling proposal and switching timing storage unit of the progress management system according to the embodiment of the invention;

FIG. 9 is a flowchart illustrating a rescheduling proposal and switching timing derivation process executed by the progress management system according to the embodiment of the invention;

FIG. 10A is an explanatory view illustrating the specific example of the rescheduling proposal and switching timing derivation process executed by the progress management system according to the embodiment of the invention;

FIG. 10B is an explanatory view illustrating the specific example of the rescheduling proposal and switching timing derivation process executed by the progress management system according to the embodiment of the invention;

FIG. 10C is an explanatory view illustrating the specific example of the rescheduling proposal and switching timing derivation process executed by the progress management system according to the embodiment of the invention;

FIG. 10D is an explanatory view illustrating the specific example of the rescheduling proposal and switching timing derivation process executed by the progress management system according to the embodiment of the invention;

FIG. 11 is a flowchart illustrating a process for instructing switching to rescheduling proposal executed by the progress management system according to the embodiment of the invention;

FIG. 12A is an explanatory view illustrating a production preparation stop instruction screen outputted by the progress management system according to the embodiment of the invention; and

FIG. 12B is an explanatory view illustrating a production preparation start instruction screen outputted by the progress management system according to the embodiment of the invention.

### DESCRIPTION OF EMBODIMENTS

One embodiment of the invention will now be described with reference to the drawings.

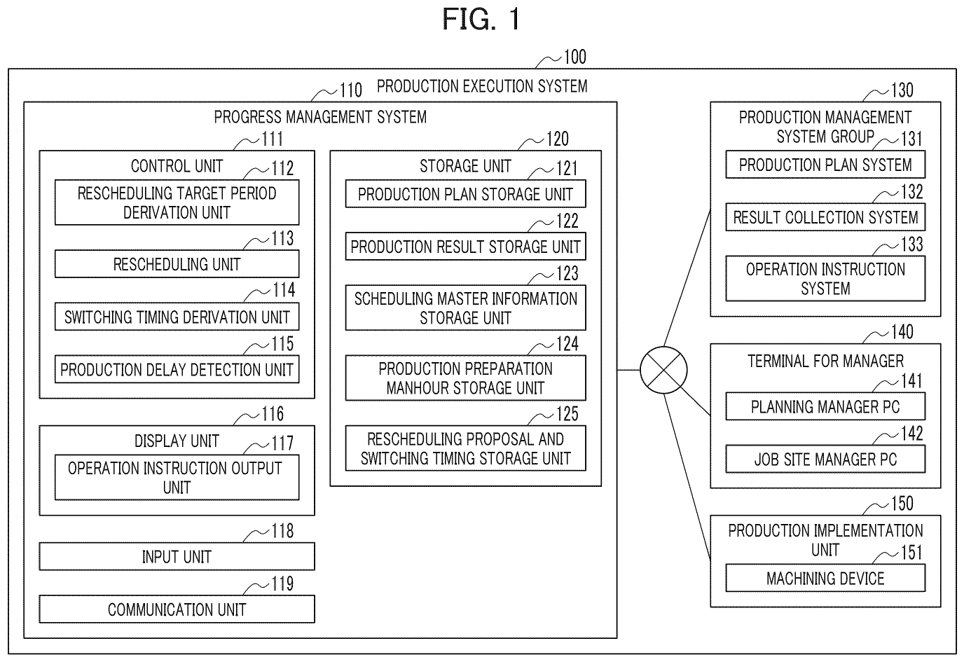

FIG. 1 is a block diagram illustrating the configuration of a production execution system according to the embodiment of the invention.

A production execution system 100 is configured of a progress management system 110, a production management system group 130, a terminal for manager 140, and a production implementation unit 150 connected via a network 160.

The progress management system 110 is a calculator system having a control unit 111, a display unit 116, an input unit 118, a communication unit 119, and a storage unit 120. The control unit 111 is, for example, a processor executing the program stored in the storage unit 120 to achieve various functions. The control unit 111 of the present embodiment has function units, such as a rescheduling target period derivation unit 112, a rescheduling unit 113, a switching timing derivation unit 114, and a production delay detection unit 115. These function units may be configured of dedicated hardware, and may be achieved by the execution of the program stored in the storage unit 120 by the control unit 111 being a general-purpose processor. Processes executed by these respective function units will be described later.

The display unit 116 is, for example, an output device such as an image display device, and has an operation instruction output unit 117. For example, the processor configuring the control unit 111 may generate image data, and instruct the display unit 116 to display its image, thereby achieving the function of the operation instruction output unit 117.

The input unit 118 is, for example, an input device such as a keyboard, a mouse, a touch panel, or the like, and receives the input of information from the user of the progress management system 110.

The communication unit 119 performs communication with the production management system group 130, the terminal for manager 140, the production implementation unit 150, and the like via the network 160.

The storage unit 120 is configured of, for example, a so-called main storage device such as a DRAM (Dynamic Random Access Memory) and of, for example, a so-called auxiliary storage device and the like, such as an HDD (Hard Disk Drive) or an SSD (Solid State Drive), and has a production plan storage unit 121, a production result storage unit 122, a scheduling master information storage unit 123, a production preparation manhour storage unit 124, and a rescheduling proposal and switching timing storage unit 125. Information stored in these storage units will be described later.

The production management system group 130 is, for example, a system managing the production of a product and the like in a factory and the like, and has a production plan system 131, a result collection system 132, and an operation instruction system 133. The production plan system 131 creates the production plan of the product and the like, specifically, for example, the plan including the allocation of each process necessary for producing the product and the like to production equipment, the start date and time and the end date and time of the process, and the like. The result collection system 132 collects information representing the actual progress of the production implemented according to the production plan. The operation instruction system 133 performs instruction to the operator, the equipment, and the like in each process according to the production plan.

The terminal for manager 140 has, for example, a planning manager PC (Personal Computer) 141 and a job site manager PC 142. The planning manager PC is, for example, a terminal device used by the manager creating the production plan (that is, the planning manager), and the production plan system 131 may create the production plan on the basis of information inputted by the operation of the planning manager PC 141 by the planning manager. The job site manager PC 142 is, for example, a terminal device used by the operator managing the operation of each process (that is, the job site manager). For example, the job site manager PC 142 may acquire the production plan from the production plan system 131 to present the production plan to the job site manager, may receive the operation instruction transmitted from the operation instruction system 133 to present the operation instruction to the job site manager, and may transmit, to the result collection system 132, the information regarding the progress of the process when the information is inputted from the job site manager.

The production implementation unit 150 has, for example, a machining device 151. This is an example of the equipment to which each process is allocated, and the production implementation unit 150 may include a plurality of machining devices 151, and may include equipment other than the machining device. For example, the production implementation unit 150 may receive the instruction transmitted from the operation instruction system 133 to control the machining device 151 according to the instruction, and may acquire the information regarding the progress of the process from the machining device 151 to transmit the information to the result collection system 132.

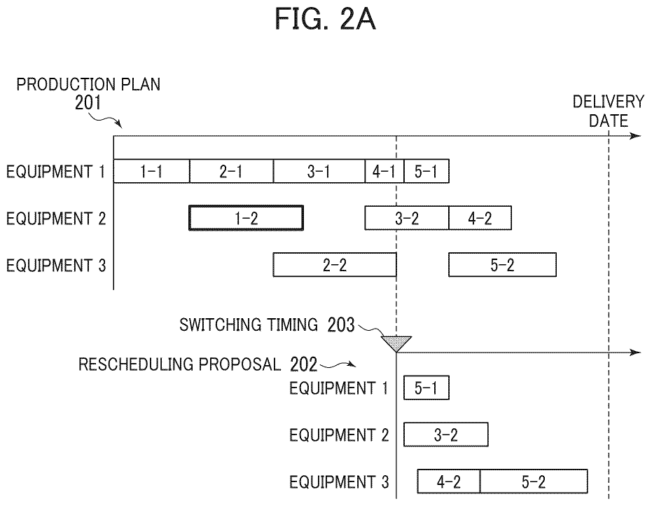

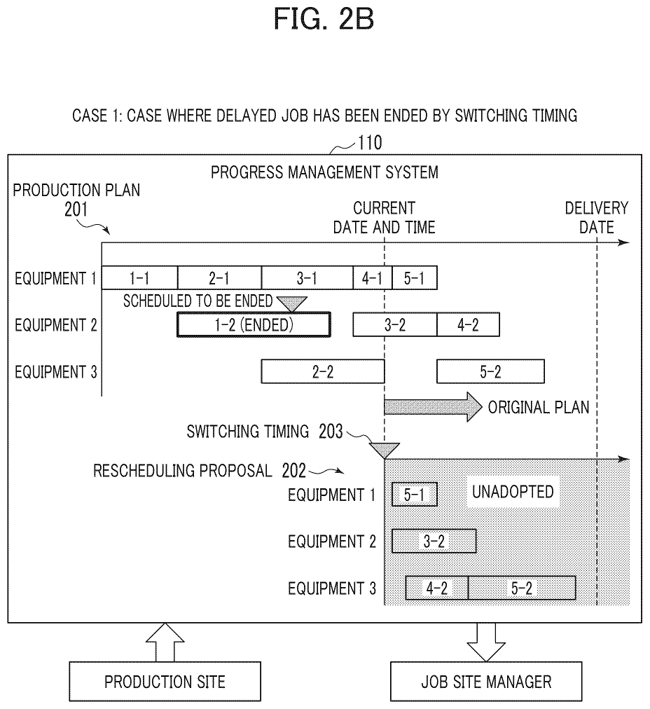

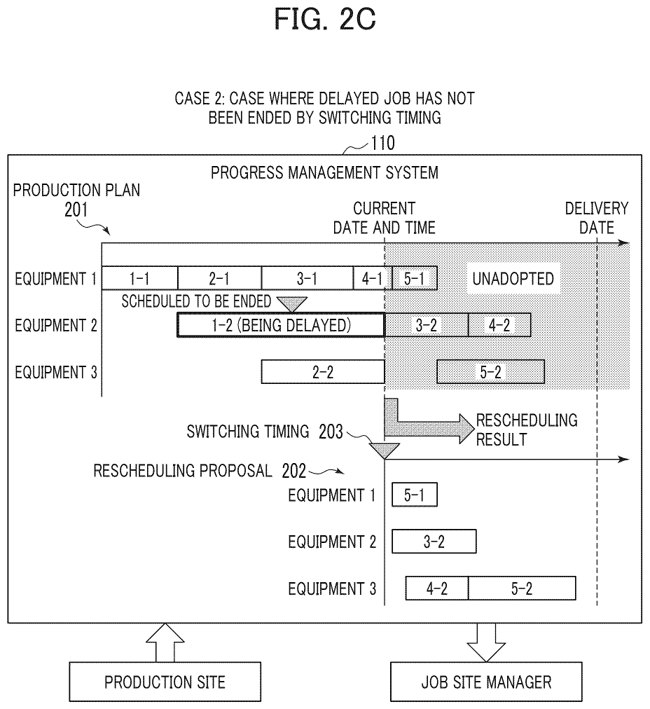

FIGS. 2A to 2C are explanatory views each illustrating the outline of progress management by the production execution system 100 according to the embodiment of the invention.

First, plan information generated in the production execution system 100 of the present embodiment will be described with reference to FIG. 2A. A production plan 201 is an example of the production plan that the progress management system 110 acquires from the production plan system 131, and here, is represented in a form of a so-called Gantt chart. The horizontal axis of the production plan 201 represents time, and each displayed block represents a job allocated to each of equipment 1 to 3. In FIG. 2A, each job is identified by the combination of the article of the product and the process number.

For example, in the example of FIG. 2A, the block displayed as “1-1” represents the job 1-1 corresponding to the operation of the first process for the product of the first article. The job 1-1 is allocated to the equipment 1, its left end represents a start date and time, and its right end represents an end date and time. Likewise, the block displayed as “2-1” represents the job 2-1 corresponding to the operation of the first process for the product of the second article. Other jobs are identified in the same manner. As described later, more precisely, the job is identified by the combination of the order ID, the article ID, and the process ID, but here, the order ID is omitted.

In the production plan 201 of FIG. 2A, first, the job 1-1 is executed in the equipment 1, and then, the job 2-1, the job 3-1, the job 4-1, and the job 5-1 are sequentially executed. On the other hand, after the end of the job 1-1, the job 1-2 is executed in the equipment 2. This represents that the product of the first article in which the first process is ended is moved from the equipment 1 to the equipment 2, and the second process is executed.

Likewise, after the end of the job 2-1, the job 2-2 is executed in the equipment 3. After the end of the job 3-1 and after the end of the job 1-2, the job 3-2 is executed in the equipment 2. After the end of the job 4-1 and after the end of the job 3-2, the job 4-2 is executed in the equipment 2. After the end of the job 5-1 and after the end of the job 2-2, the job 5-2 is executed in the equipment 3.

In the present embodiment, the progress management system 110 generates a rescheduling proposal, and further calculates a switching point from the original production plan to the rescheduling proposal. The rescheduling proposal is generated for each job included in the production plan. As an example, FIG. 2A illustrates a rescheduling proposal 202 corresponding to the job 1-2 and a switching timing 203 to the rescheduling proposal 202.

In the rescheduling proposal 202, the job 4-2 is changed to be executed in the equipment 3 after the the end of the job 4-1 and after the end of the job 2-2. In addition, the job 5-2 is changed to be executed in the equipment 3 after the the end of the job 5-1 and after the end of the job 4-2.

Note that, after the production plan 201 is generated, the rescheduling proposal 202 and the switching timing 203 are desirably generated by the time the execution of the job based on the production plan is started.

Next, an example of the progress of the job for the case in which after the start of the execution of the job based on the production plan 201 illustrated in FIG. 2A, a delay has occurred in the job 1-2 will be described.

FIG. 2B illustrates an example for the case in which although the end of the job 1-2 has been delayed (that is, the job 1-2 has not been ended by the scheduled end date and time in the production plan 201), the job 1-2 has been ended at the point of time before the switching timing 203. The progress management system 110 grasps the progress of each job on the basis of the production result from the production site. In the example of FIG. 2B, the job 1-2 has been ended at the point of time before the switching timing 203. In this case, the rescheduling proposal 202 is not adopted, and the job is executed on the basis of the production plan 201 also after the switching timing 203. That is, the progress management system 110 outputs the operation instruction based on the original production plan 201 to the production site (for example, the job site manager or the control device and the like of the equipment) also after the switching timing.

On the other hand, FIG. 2C illustrates an example for the case in which the end of the job 1-2 is delayed, and has not been ended yet even at the reaching of the switching timing 203. In this case, the production plan 201 is switched to the rescheduling proposal 202 at the switching timing 203. That is, the portion of the production plan 201 after the switching timing 203 is not adopted, and after the switching timing 203, the job is executed on the basis of the rescheduling proposal 202. That is, the progress management system 110 outputs the operation instruction based on the rescheduling proposal 202 to the production site after the switching timing. As a result, all the jobs are ended by the delivery date, so that the productivity is prevented from being lowered.

FIG. 3 is an explanatory view illustrating the outline of the entire production execution by the production execution system 100 according to the embodiment of the invention.

The planning manager makes a production plan 302 for a certain day (here, an N day is described) (step 301). For example, the production plan system 131 may make the production plan 302 on the basis of information inputted by the operation of the planning manager PC 141 by the planning manager (the same shall apply hereinafter). The production plan 302 is transmitted to the progress management system 110 to be stored in the production plan storage unit 121, and is transmitted to the job site manager, so that the production based on the production plan 302 is implemented (step 303). At this time, the production plan may be transmitted to the production implementation unit 150 to automatically implement the production (the same shall apply hereinafter).

The result of the implemented production is collected by the result collection system 132, is transmitted to the progress management system 110, and is held as a production result 304 by the production result storage unit 122.

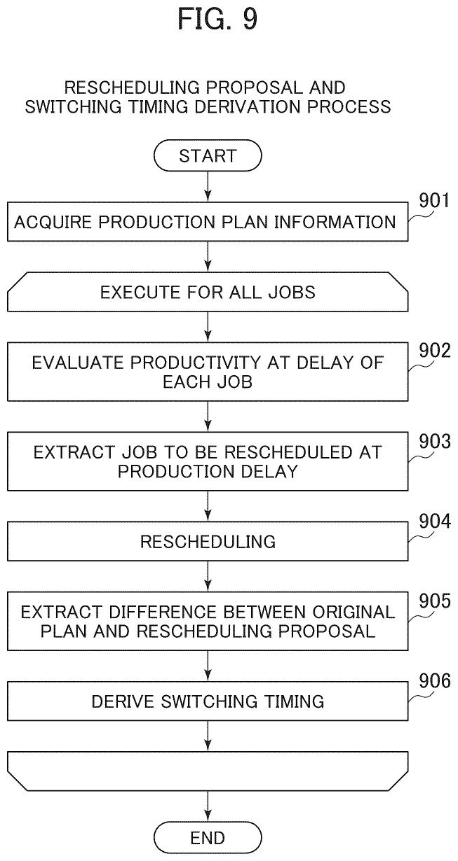

The progress management system 110 derives, on the basis of the production plan 302, the rescheduling proposal for the production plan and the switching timing representing the timing switching the production plan to the rescheduling proposal (step 305). This derivation is desirably executed to be ended before the implementation of the production (step 303) is started, and at the latest, is desirably ended before the scheduled end date and time of the job that is executed first on the basis of the production plan 302. The detail of the rescheduling proposal and switching timing derivation process will be described later (see FIG. 9 and the like).

The progress management system 110 refers to the production result 304, and instructs switching to the rescheduling proposal derived in step 305 when the job has not been completed even at the reaching of the switching timing (step 306). Specifically, the progress management system 110 transmits the rescheduling proposal generated in step 305 to the job site manager and the like, and thereafter, the production based on the rescheduling proposal is implemented (step 303). The result of the implemented production is collected as a production result 310, and is held.

In addition, the rescheduling proposal is transmitted also to the planning manager, and the production plan system 131 makes the production plan based on the rescheduling proposal (step 307). This plan making can be executed like step 301 except that the plan making is executed on the basis of the rescheduling proposal. A production plan 308 that is made is stored in the production plan storage unit 121.

The progress management system 110 derives the rescheduling proposal and the switching timing like step 305 on the basis of the production plan 308 (step 309). Then, the progress management system 110 refers to the production result 310, and instructs switching to the rescheduling proposal derived in step 309 when the job has not been completed even at the reaching of the switching timing (step 311).

Although the illustration of the subsequent process is omitted, the same processes as above are repeated until the production for the N day is ended.

Thereafter, the planning manager makes a production plan 313 for the next day (N+1 day) on the basis of the production result acquired last on the N day (for example, the production result 310) (step 312). The production is implemented on the basis of the production plan 313 (step 314), and a production result 315 acquired as the result is held. The progress management system 110 derives the rescheduling proposal and the switching timing on the basis of the production plan 313 (step 316). Then, the progress management system 110 refers to the production result 315, and instructs switching to the rescheduling proposal derived in step 316 when the job has not been completed even at the reaching of the switching timing (step 317). These processes are executed in the same manner as the processes executed on the N day.

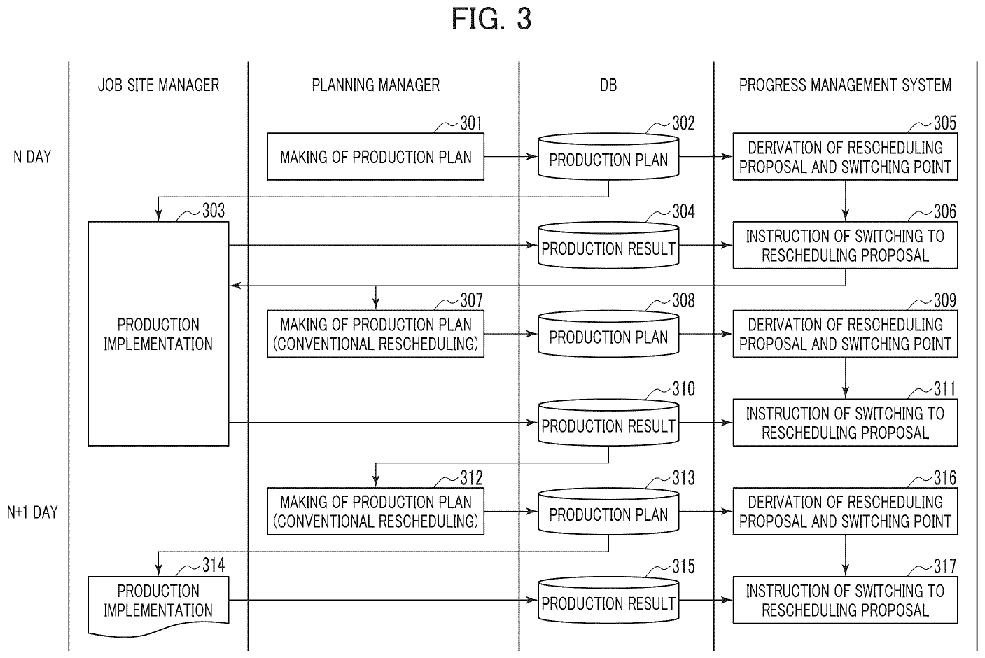

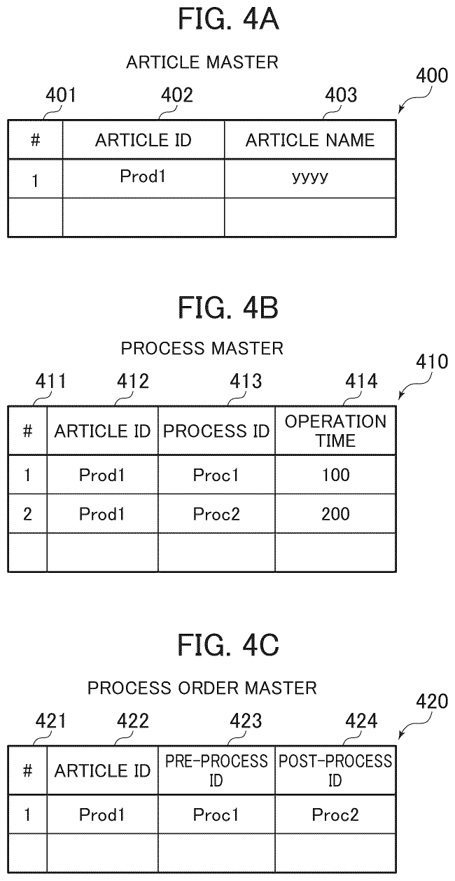

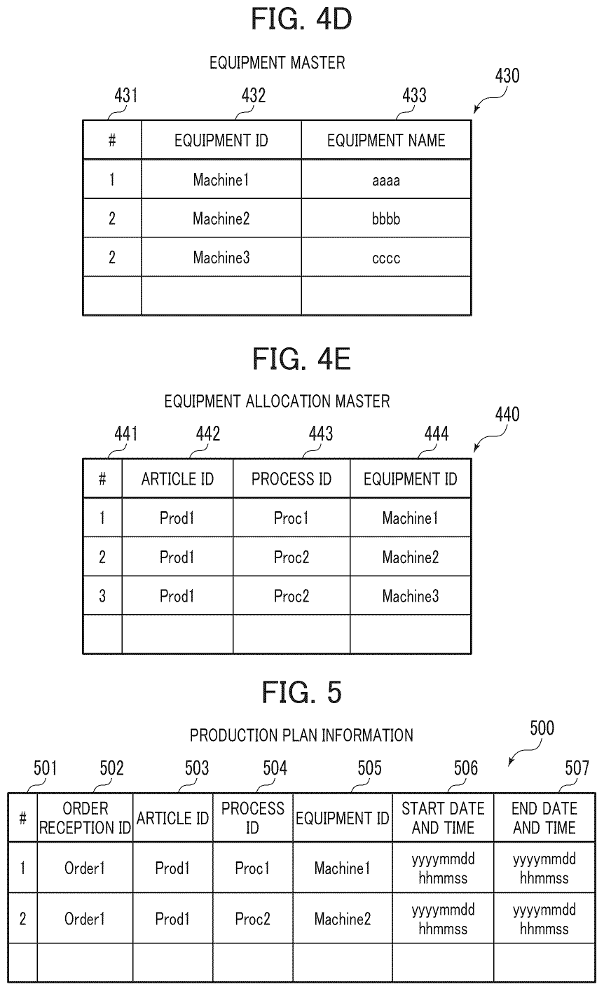

Next, information held in the production execution system 100 will be described with reference to FIGS. 4A to 8B. Here, for convenience of description, the example of information in a table form is represented, but information actually held is not necessarily in the table form, and its form is not limited as long as information equal to the following description is included.

FIG. 4A is an explanatory view illustrating article master information held by the scheduling master information storage unit 123 of the progress management system 110 according to the embodiment of the invention.

Article master information 400 illustrated in FIG. 4A is an example of information representing the article of each product to be produced. Specifically, the article master information 400 is configured of one or more records each including a serial number 401, an article ID 402, and an article name 403. The serial number 401 is a number identifying each record. The article ID 402 and the article name 403 are information identifying the article of the product to be produced. Note that in the present embodiment, the production target is described as the product, but the “product” herein may be a so-called final product, and may be a part used for producing the final product.

FIG. 4B is an explanatory view illustrating process master information held by the scheduling master information storage unit 123 of the progress management system 110 according to the embodiment of the invention.

Process master information 410 illustrated in FIG. 4B is an example of information representing the process necessary for producing each product. Specifically, the process master information 410 is configured of one or more records each including a serial number 411, an article ID 412, a process ID 413, and an operation time 414. The serial number 411 is a number identifying each record. The article ID 412 is information identifying the article of the product to be produced. The process ID 413 is information identifying the process necessary for producing each product. Typically, a plurality of processes are required for producing one product, and in the example of FIG. 4B, the information of each process is held by each record. The operation time 414 represents the operation time of each process.

FIG. 4C is an explanatory view illustrating process order master information held by the scheduling master information storage unit 123 of the progress management system 110 according to the embodiment of the invention.

Process order master information 420 illustrated in FIG. 4C is an example of information representing the order in which the process is executed. Specifically, the process order master information 420 is configured of one or more records each including a serial number 421, an article ID 422, a pre-process ID 423, and a post-process ID 424. The serial number 421 is a number identifying each record. The article ID 422 is information identifying the article of the product to be produced. The pre-process ID 423 and the post-process ID 424 are information identifying, of a plurality of processes for producing each product, the process to be executed first and the process to be executed next, respectively.

FIG. 4D is an explanatory view illustrating equipment master information held by the scheduling master information storage unit 123 of the progress management system 110 according to the embodiment of the invention.

Equipment master information 430 illustrated in FIG. 4D is an example of information representing the equipment used for producing the product. Specifically, the equipment master information 430 is configured of one or more records each including a serial number 431, an equipment ID 432, and an equipment name 433. The serial number 431 is a number identifying each record. The equipment ID 432 and the equipment name 433 are information identifying each equipment.

FIG. 4E is an explanatory view illustrating equipment allocation master information held by the scheduling master information storage unit 123 of the progress management system 110 according to the embodiment of the invention.

Equipment allocation master information 440 illustrated in FIG. 4E is an example of information representing the equipment to which each process can be allocated. Specifically, the equipment allocation master information 440 is configured of one or more records each including a serial number 441, an article ID 442, a process ID 443, and an equipment ID 444. The serial number 441 is a number identifying each record. The article ID 442 is information identifying the article of each product. The process ID 443 is information identifying each process. The equipment ID 444 is information identifying the equipment to which each process for each product can be allocated. Typically, a plurality of pieces of equipment to which the same process can be allocated may be present, and in that case, in the example of FIG. 4E, the information of the combination of one process and one piece of equipment is held by one record.

Here, the specific examples illustrated in FIGS. 4A to 4E will be described.

To produce the product identified by the article ID “Prod1”, at least the process identified by the process ID “Proc1” and the process identified by the process ID “Proc2” are required, and the operation times of the respective processes are “100 hours” and “200 hours” (FIG. 4B). Of these processes, the “Proc1” is required to be executed first, and the “Proc2” is required to be executed next (FIG. 4C). Then, the “Proc1” can be allocated to the equipment identified by the equipment ID “Machine1”, and the “Proc2” can be allocated to both of the equipment identified by the equipment ID “Machine2” and the equipment identified by the equipment ID “Machine3”.

FIG. 5 is an explanatory view illustrating production plan information held by the production plan storage unit 121 of the progress management system 110 according to the embodiment of the invention.

Production plan information 500 illustrated in FIG. 5 is configured of a plurality of records each corresponding to one job. Each record includes a serial number 501, an order reception ID 502, an article ID 503, a process ID 504, an equipment ID 505, a start date and time 506, and an end date and time 507.

The serial number 501 is a number identifying each record. The order reception ID 502 is information representing to which order the product to be produced corresponds. The article ID 503 is information identifying the article of the product to be produced. The process ID 504 is information identifying the process for producing the product. Since in the actual production site, a plurality of products of the same article may be produced according to a plurality of orders, each individual of the product as the target of each job is uniquely identified by the combination of the order reception ID and the article ID (that is, to which order the product is produced and to which article the product belongs). Then, each job is uniquely identified by the combination of the order reception ID, the article ID, and the process ID. The equipment ID 505 is information identifying the equipment to which each process for each product is allocated. The start date and time 506 and the end date and time 507 represent the date and time in which each process is scheduled to be started and the date and time in which each process is scheduled to be ended, respectively.

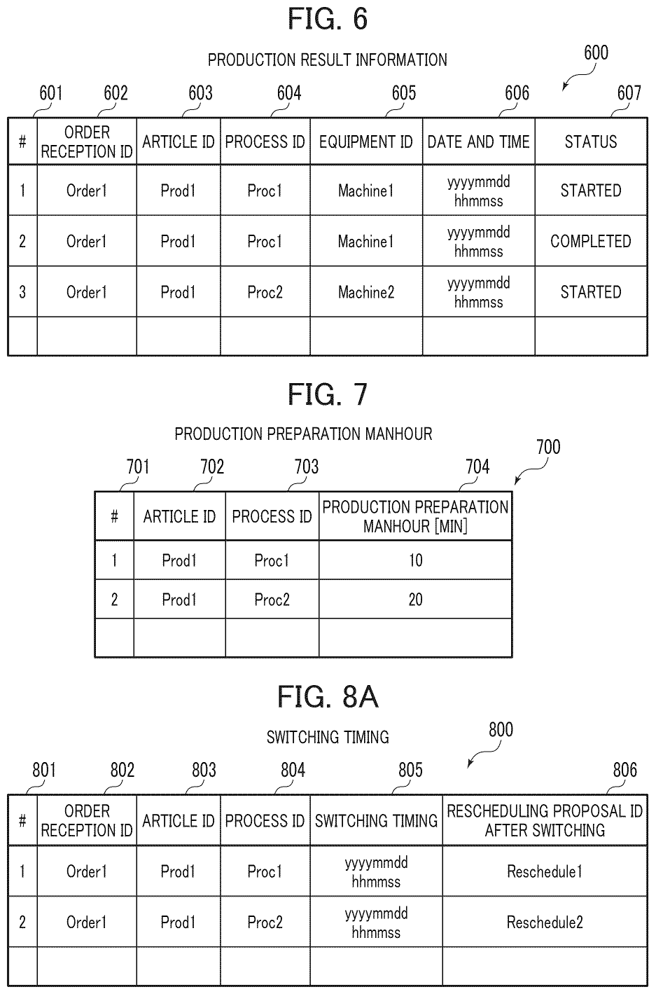

FIG. 6 is an explanatory view illustrating production result information held by the production result storage unit 122 of the progress management system 110 according to the embodiment of the invention.

Each record of production result information 600 illustrated in FIG. 6 includes a serial number 601, an order reception ID 602, an article ID 603, a process ID 604, an equipment ID 605, a date and time 606, and a status 607. Since the serial number 601 to the equipment ID 605 are similar to the serial number 501 to the equipment ID 505 illustrated in FIG. 5, the description thereof is omitted. The date and time 606 and the status 607 represent the date and time in which the progress status of each process is acquired and the acquired progress status, respectively.

Here, the specific examples illustrated in FIGS. 5 and 6 will be described.

The example of FIG. 5 represents that, for the product to be produced identified by the order reception ID “Order1” and the article ID “Prod1”, the process identified by the process ID “Proc1” and the process identified by the process ID “Proc2” are sequentially executed, that the respective processes are allocated to the equipment identified by the equipment ID “Machine1” and the equipment identified by the equipment ID “Machine2”, respectively, and the start date and time and the end date and time of each process.

Then, the example of FIG. 6 represents that of the above processes, the “Proc1” has been already started and has also been completed, and the “Proc2” has been started, but has not been completed (that is, the “Proc2” is being currently executed).

FIG. 7 is an explanatory view illustrating production preparation manhour information held by the production preparation manhour storage unit 124 of the progress management system 110 according to the embodiment of the invention.

Production preparation manhour information 700 illustrated in FIG. 7 includes information representing the manhour required for preparation executing each process. Specifically, the production preparation manhour information 700 is configured of one or more records each including a serial number 701, an article ID 702, a process ID 703, and a production preparation manhour 704. The serial number 701 is a number identifying each record. The article ID 702 is information identifying the article of each product. The process ID 703 is information identifying each process. The production preparation manhour 704 represents the manhour required for preparation executing each process for each product.

In the example of FIG. 7, “10 (min)” is held as the production preparation manhour 704 corresponding to the article ID “Prod1” and the process ID “Proc1”, and “20 (min)” is held as the production preparation manhour 704 corresponding to the article ID “Prod1” and the process ID “Proc2”. This represents that the 10 minutes and the 20 minutes are required for preparation executing the respective processes (for example, material carrying-in, jig mounting, or the like).

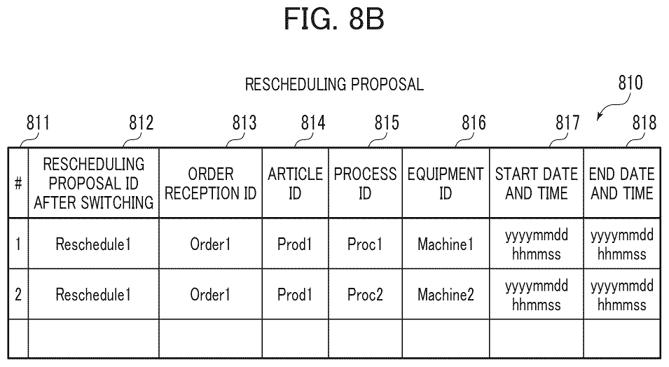

FIG. 8A is an explanatory view illustrating switching timing information held by the rescheduling proposal and switching timing storage unit 125 of the progress management system 110 according to the embodiment of the invention.

Switching timing information 800 illustrated in FIG. 8A is configured of a plurality of records each including a serial number 801, an order reception ID 802, an article ID 803, a process ID 804, a switching timing 805, and a rescheduling proposal ID after switching 806.

The serial number 801 is a number identifying each record. The order reception ID 802 is information representing to which order the product to be produced corresponds. The article ID 803 is information identifying the article of the product to be produced. The process ID 804 is information identifying the process for producing the product. The rescheduling proposal ID after switching 806 and the switching timing 805 represent information identifying the rescheduling proposal switching the production plan and the date and time calculated as the timing switching the production plan to the rescheduling proposal, respectively.

FIG. 8B is an explanatory view illustrating rescheduling proposal information held by the rescheduling proposal and switching timing storage unit 125 of the progress management system 110 according to the embodiment of the invention.

Rescheduling proposal information 810 illustrated in FIG. 8B is configured of a plurality of records each including a serial number 811, a rescheduling proposal ID after switching 812, an order reception ID 813, an article ID 814, a process ID 815, an equipment ID 816, a start date and time 817, and an end date and time 818.

The serial number 811 is a number identifying each record. The rescheduling proposal ID after switching 812 is information identifying the generated rescheduling proposal, and corresponds to the rescheduling proposal ID after switching 806 illustrated in FIG. 8A. Since the order reception ID 813, the article ID 814, and the process ID 815 are similar to the order reception ID 802, the article ID 803, and the process ID 804 illustrated in FIG. 8A, respectively, the description thereof is omitted. The start date and time 817 and the end date and time 818 represent the start date and time and the end date and time based on each rescheduling proposal, respectively.

FIG. 9 is a flowchart illustrating the rescheduling proposal and switching timing derivation process executed by the progress management system 110 according to the embodiment of the invention.

The process illustrated in FIG. 9 is an example of the process executed in steps 305, 309, and 316 of FIG. 3. First, the progress management system 110 acquires the production plan (for example, the production plan 302, 308, or 313 of FIG. 3) from the production plan system 131 (step 901). The acquired production plan is stored in the production plan storage unit 121 as, for example, the production plan information 500.

Next, the progress management system 110 executes steps 902 to 906 by targeting each job included in the acquired production plan. These processes are repeatedly executed until these processes are ended for all the jobs included in the acquired production plan.

First, the rescheduling target period derivation unit 112 of the progress management system 110 evaluates the productivity for the case in which the job to be processed (hereinafter, described as a target job) is delayed (step 902). Here, as an example of the evaluation of the productivity, an example in which whether or not the delivery date delay of any one of the products occurs is represented. Since at this point in time, the delay of the actual job has not occurred yet, whether or not the delivery date delay occurs is predicted by simulation and the like. For example, the delay amount of the end of the actual target job with respect to the date and time in which the end date and time of the target job is scheduled by the production plan, for causing the delivery date delay of any one of the products, in other words, the delay amount of the target job causing the delivery date delay, is calculated by, for example, simulation and the like.

However, the occurrence of the delivery date delay is an example of the productivity evaluation index, and the productivity may be evaluated on the basis of the different index, such as, for example, the operation rate of the equipment. For example, when the productivity is evaluated on the basis of the operation rate of the equipment, the allowable lower limit of the operation rate may be previously defined, and the delay amount of the target job for a case where the operation rate is below the lower limit may be calculated by simulation and the like.

Next, the rescheduling target period derivation unit 112 extracts the job to be rescheduled for the case in which the end of the target job is delayed (step 903). For example, the rescheduling target period derivation unit 112 may extract, as the job to be rescheduled, among the jobs included in the production plan, the job that has not been started yet in the scheduled end date and time of the target job (that is, the job in which the value of the start date and time 506 is later than the value of the end date and time 507 of the target job).

Next, the rescheduling unit 113 of the progress management system 110 performs rescheduling by targeting the job to be rescheduled extracted in step 903 (step 904). For example, the rescheduling unit 113 performs rescheduling such that the delivery date delay does not occur in all the products targeted in the production plan. As the method for rescheduling, for example, any method, such as exhaustive search or mathematical optimization, can be adopted. With this, the rescheduling proposal in which for at least one of the jobs to be rescheduled, at least one of the allocation to the equipment and the start date and time is changed is generated.

Next, the switching timing derivation unit 114 of the progress management system 110 extracts the difference between the original production plan and the rescheduling proposal (step 905). Specifically, for example, when at least one of the equipment to which the job is allocated or the start date and time of the job is changed by rescheduling, the change of one of them is extracted as the difference between the original production plan and the rescheduling proposal.

Next, the switching timing derivation unit 114 derives the switching timing (step 906). For example, the switching timing derivation unit 114 may identify the date and time obtained by going back from the start date and time of each job in which the difference is extracted, by the time for the production preparation manhour of the job, and extract, as the switching timing, the earliest date and time among the identified dates and times.

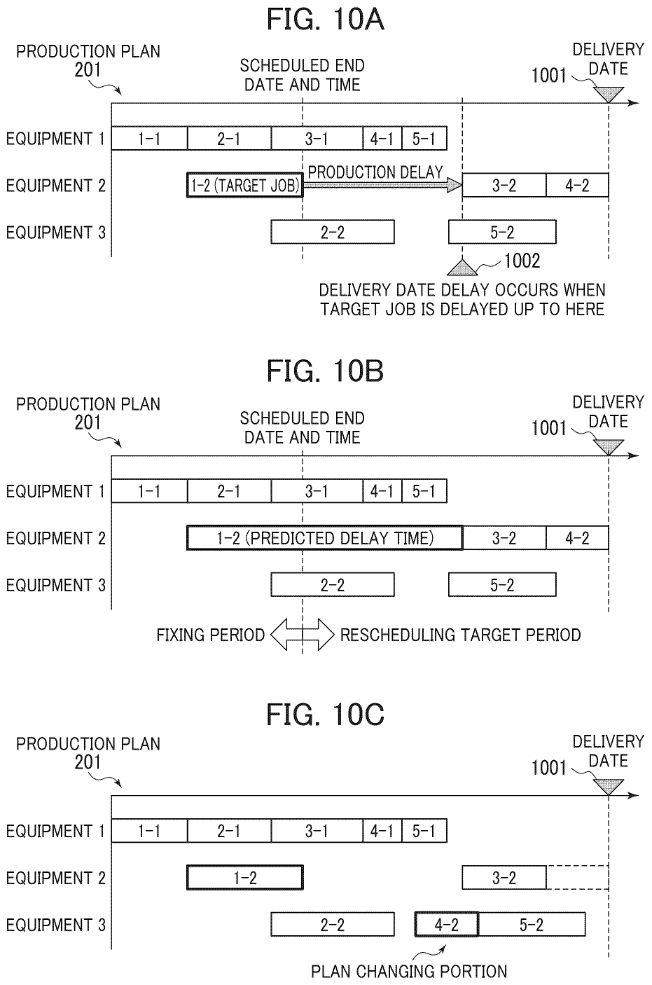

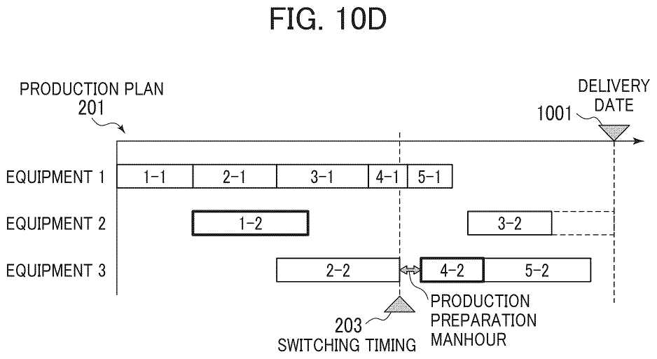

Here, the specific examples of the processes illustrated in FIG. 9 will be described with reference to FIGS. 10A to 10D.

FIGS. 10A to 10D are explanatory views illustrating the specific examples of the rescheduling proposal and switching timing derivation process executed by the progress management system 110 according to the embodiment of the invention.

First, the specific example of step 902 will be described with reference to FIG. 10A. Here, a case where the job 1-2 of the production plan 201 illustrated in FIG. 2A is the target job is represented. Here, the rescheduling target period derivation unit 112 judges whether the productivity is lowered when the end of the job 1-2 is delayed.

For example, when the end of the job 1-2 is delayed, the job 3-2 and the job 4-2 executed in the equipment 2 after the job 1-2 may be sequentially delayed. In addition, when the end of the job 1-2 is delayed, the start and end of the job 2-2 in the equipment 3 corresponding to the next process with respect to the same product may also be delayed, and further, the subsequent job 502 in the equipment 3 may also be delayed.

For example, the rescheduling target period derivation unit 112 performs the simulation of the production while delaying the end date and time of the job 1-2 little by little, and identifies, when the delivery date delay occurs first in any one of the products, the delay amount at that time as the delay amount causing the delivery date delay. That is, the end date and time of the job 1-2 at that time is identified as the earliest end date and time of the target job causing the delivery date delay.

In the example of FIG. 10A, an end date and time 1002 of the job 1-2 for the case in which the end date and time of the job 4-2 corresponding to the last process for the fourth product reaches a delivery date 1001 is identified. Hereinbelow, FIGS. 10B to 10D illustrate examples for the case in which the end date and time 1002 is identified for the job 1-2.

Next, the specific example of step 903 will be described with reference to FIG. 10B. In this example, the fixing period is the period before the scheduled end date and time of the job 1-2, and the rescheduling target period is the period after the scheduled end date and time of the job 1-2. Then, the job started in the rescheduling target period is extracted as the job to be rescheduled. In the example of FIG. 10B, the job 4-1, the job 5-1, the job 3-2, the job 4-2, and the job 5-2 are extracted as the jobs to be rescheduled.

Next, the specific example of step 905 will be described with reference to FIG. 10C. In this example, as the result of the delay of the job 1-2, the start of the job 3-2 is delayed, and further, as the result of the rescheduling (step 904), the job 4-2 is allocated to the equipment 3, and the job 5-2 is executed after the job 4-2. For this, as the differences between the original production plan and the rescheduling proposal, the start date and time and the end date and time of the job 3-2, the equipment to which the job 4-2 is allocated, the start date and time and the end date and time of the job 4-2, and the start date and time and the end date and time of the job 5-2 are extracted.

Next, the specific example of step 906 will be described with reference to FIG. 10D. In this example, for each of the job 3-2, the job 4-2, and the job 5-2 in which the differences are extracted, the production preparation manhour information 700 is referred to identify the date and time obtained by going back from the start date and time of each of the jobs by the time for the production preparation manhour. Then, among those dates and times, the earliest date and time is identified as the switching timing. In the example of FIG. 10D, the date and time obtained by going back from the start date and time of the job 4-2 by only the value of the production preparation manhour 704 of the process corresponding to the job is identified as the switching timing 203.

Note that FIGS. 10A to 10D illustrate the example of the rescheduling proposal and switching timing derivation for the case in which the job 1-2 is the target job, but actually, with the loop of the process of FIG. 9, by targeting all the jobs included in the production plan, the rescheduling proposal and the switching timing corresponding to each job are derived.

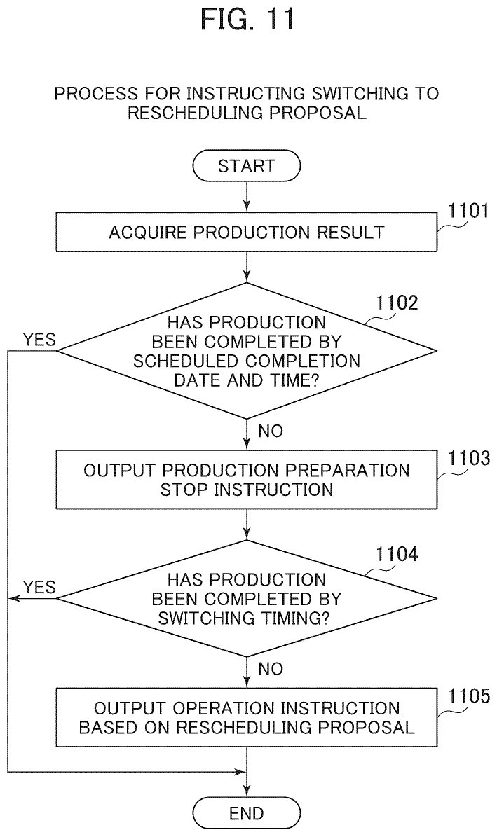

FIG. 11 is a flowchart illustrating a process for instructing switching to rescheduling proposal executed by the progress management system 110 according to the embodiment of the invention.

The process illustrated in FIG. 11 is executed after the production plan is made, the derivation of the rescheduling proposal and the switching timing corresponding to each job in the production plan is ended, and the production based on the production plan is started. That is, the process illustrated in FIG. 11 is an example of the process executed in steps 306, 311, and 317 of FIG. 3.

First, the production delay detection unit 115 of the progress management system 110 acquires, from the result collection system 132, the production result (for example, the production result 304, 310, or 315 of FIG. 3) (step 1101). The acquired production result is stored in the production result storage unit 122, as, for example, the production result information 600.

Next, the production delay detection unit 115 compares the production result information 600 with the production plan information 500, and thus judges whether the job has been ended by the scheduled end date and time (that is, the end date and time 507 corresponding to the job) (step 1102).

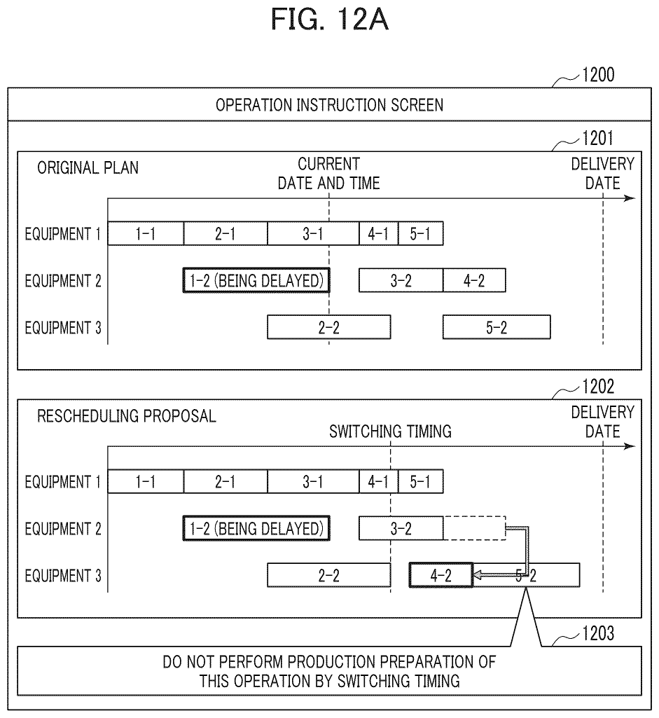

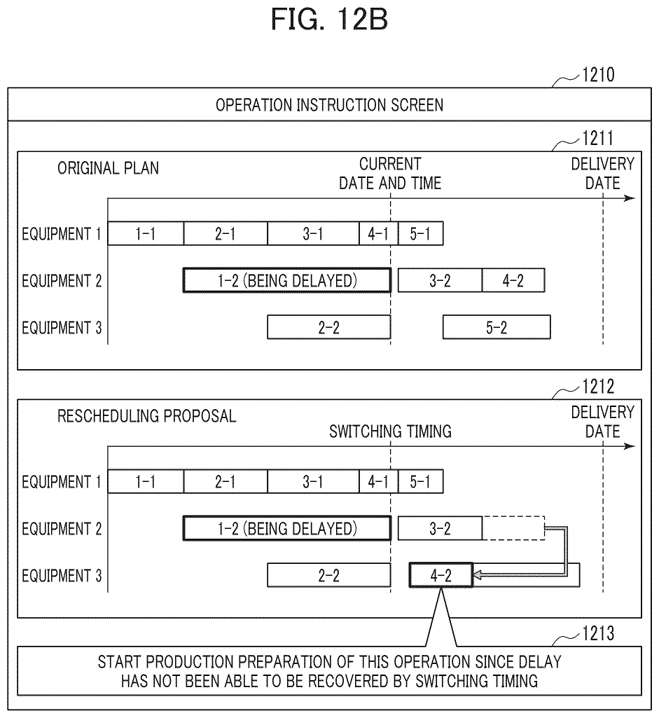

In the case where it is judged in step 1102 that the job has not been ended by the scheduled end date and time (step 1102: No), the delay of the job is detected. In this case, the operation instruction output unit 117 of the progress management system 110 outputs a production preparation stop instruction for the job that has not been started yet at that point (step 1103). As illustrated in FIG. 12A described later, this may be outputted as the message to the job site manager, and may be outputted as the signal for controlling the equipment.

Next, the production delay detection unit 115 judges whether the job in which the delay has been detected has been ended by the switching timing corresponding to the job (step 1104). In the case where the job has not been ended by the switching timing (step 1104: No), the operation instruction output unit 117 outputs the operation instruction based on the rescheduling proposal corresponding to the job (step 1105). That is, in this case, the original production plan after that point in time is not adopted, and the rescheduling proposal is newly adopted. Note that the operation instruction in step 1105 may be outputted as the message to the job site manager as illustrated in FIG. 12B described later, and may be outputted as the signal for controlling the equipment.

In the case where it is judged in step 1102 that the job has been ended by the scheduled end date and time (step 1102: Yes), steps 1103 to 1105 are not executed. In addition, in the case where it is judged in step 1104 that the job has been ended by the switching timing (step 1104: Yes), step 1105 is not executed. Note that the case where it is judged in step 1104 that the job has been ended by the switching timing also includes the case where although the job has not been ended yet, the current date and time has not reached the switching timing yet.

FIG. 12A is an explanatory view illustrating a production preparation stop instruction screen outputted by the progress management system 110 according to the embodiment of the invention.

A production preparation stop instruction screen 1200 illustrated in FIG. 12A is an example of the screen outputted by the operation instruction output unit 117 in step 1103. Specifically, the production preparation stop instruction screen 1200 includes an original plan display unit 1201, a rescheduling proposal display unit 1202, and a message display unit 1203. Here, represented is the example of the screen displayed in the case where although the job based on the production plan 201 illustrated in FIG. 2A has been executed to detect the delay of the job 1-2, the current date and time has not reached the switching timing corresponding to the job 1-2 yet.

The original plan display unit 1201 displays the original production plan, that is, the production plan based on the production plan information 500. However, in this example, since the delay of the job 1-2 has been detected, the delay is reflected on the display. Specifically, the block indicating the job 1-2 is extended to the current date and time, and further, the letters “being delayed” are displayed.

The rescheduling proposal display unit 1202 displays the production plan obtained by replacing, with the rescheduling proposal, the original production plan after the switching timing corresponding to the job in which the delay has been detected. In the example of FIG. 12A, like the rescheduling proposal 202 illustrated in FIG. 2A, the job 4-2 is changed to be executed in the equipment 3 before the job 5-2. The rescheduling proposal display unit 1202 may display information displaying such change (for example, an arrow and the like indicating the moving source and the moving destination of the job).

The message display unit 1203 displays the message to the job site manager. In the example of FIG. 12A, since the current date and time has not reached the switching point yet, the possibility that switching to the rescheduling proposal is not performed remains. However, if the production preparation of the job executed from now on according to the original production plan is started, the excessive manhour for re-executing the production preparation occurs in the case where switching to the rescheduling proposal becomes necessary, so that the productivity can be lowered. To prevent that, displayed is the message that instructs not to start the production preparation of the job (in the example of FIG. 12A, at least the job 5-2) changed by switching to the rescheduling proposal by the time of reaching the switching timing after the current date and time.

FIG. 12B is an explanatory view illustrating a production preparation start instruction screen outputted by the progress management system 110 according to the embodiment of the invention.

A production preparation start instruction screen 1210 illustrated in FIG. 12B is an example of the screen outputted by the operation instruction output unit 117 in step 1105. Specifically, the production preparation start instruction screen 1210 includes an original plan display unit 1211, a rescheduling proposal display unit 1212, and a message display unit 1213. Here, illustrated is the example of the screen displayed in the case where the delay of the job 1-2 illustrated in FIG. 12A has not been eliminated yet even when the current date and time has reached the switching timing.

The display contents of the original plan display unit 1211 and the scheduling proposal display unit 1212 are almost the same as the display contents of the original plan display unit 1201 and the rescheduling proposal display unit 1202 illustrated in FIG. 12A, respectively. However, in the example of FIG. 12B, the delay of the job 1-2 has reached the current date and time (that is, the switching timing). For this, the original plan display unit 1211 displays that the end of the job 1-2 is delayed to the current date and time, and with that, the job 3-2 and the job 4-2 that are scheduled to be executed in the equipment 2 after the job 1-2 are also delayed. On the other hand, the scheduling proposal display unit 1212 displays that the job 4-2 is executed in the equipment 3 before the job 5-2.

The message display unit 1213 displays the message to the job site manager. In the example of FIG. 12B, since the rescheduling proposal is decided to be adopted, the message instructing the start of the production preparation based on the rescheduling proposal (specifically, the production preparation of the job 4-2 in the equipment 3) is displayed.

In addition, the system of the embodiment of the invention may be configured as follows.
(1) A progress management system (for example, the progress management system 110) has a control unit (for example, the control unit 111) and a storage unit (for example, the storage unit 120), the storage unit holds a production plan for one or more products (for example, the production plan information 500), the production plan includes, for each product and each process for producing the product, the allocation of the operation of the process (for example, the job) to equipment (for example, the equipment ID 505), a scheduled start time (for example, the start date and time 506) for the operation of the process, and a scheduled end time (for example, the end date and time 507) for the operation of the process, the control unit predicts, on the basis of the production plan, productivity for the case in which the operation of the process is delayed (for example, step 902), and on the basis of the delay amount of the operation of the process for the case in which it is predicted that the productivity will not satisfy a predetermined standard, the control unit generates a changing proposal (for example, the rescheduling proposal) for the production plan and a switching timing to the changing proposal for the production plan such that the productivity satisfies the predetermined standard when the delay of the delay amount occurs in the operation of the process (for example, steps 904 to 906).

With this, even when the delay of the process occurs, the production plan can be switched to the suitable changing proposal before the timing at which the productivity cannot be maintained is reached, and with this, the productivity can be prevented from being lowered.
(2) In the above (1), the control unit generates the changing proposal changing at least one of the allocation to the equipment and the scheduled start time of, among the operations of the processes included in the production plan, at least one of the operations of the processes in which the scheduled start time is later than the scheduled end time of the operation of the process for the case in which the delay in which it is predicted that the productivity will not satisfy the predetermined standard occurs (for example, steps 903 to 906).

With this, even when the delay of the process occurs, the production plan can be switched to the suitable changing proposal before the timing at which the productivity cannot be maintained is reached, and with this, the productivity can be prevented from being lowered.
(3) In the above (2), the storage unit further holds, for each combination of the article of the product and the process, a production preparation manhour (for example, the production preparation manhour information 700) that is a manhour necessary for preparation starting the operation of the process, and the control unit calculates a time starting preparation on the basis of the production preparation manhour for the operation of each of the processes changed in the changing proposal, and identifies, as the switching timing, the earliest time among the calculated times (step 906).

With this, also in consideration of the time required for the preparation of the production, the switching timing to the changing proposal for preventing the productivity from being lowered can be precisely calculated.
(4) In the above (1), the control unit predicts that the productivity will not satisfy the predetermined standard when it is predicted that the delivery date of any one of the products will be delayed.

With this, even when the delay of the process occurs, the delivery date can be prevented from being delayed.
(5) In the above (1), the control unit predicts that the productivity will not satisfy the predetermined standard when it is predicted that the operation rate of the equipment will become lower than the predetermined standard.

With this, even when the delay of the process occurs, the operation rate of the equipment can be prevented from being lowered.
(6) In the above (1), the control unit generates the changing proposal for the production plan and the switching timing to the changing proposal for the production plan before the operation of the process based on the production plan is started.

With this, even when the delay of the process occurs, the production plan can be switched to the suitable changing proposal before the timing at which the productivity cannot be maintained is reached, and with this, the productivity can be prevented from being lowered.
(7) In the above (1), the control unit acquires the result of the operation of each of the processes after the operation of the process based on the production plan is started, and when detecting, on the basis of the acquired result and the production plan, the delay of the operation of any one of the processes, the control unit outputs an instruction to stop the preparation of the operation of the process started after that point in time (for example, step 1103).
(8) In the above (7), the control unit outputs the instruction of the operation of the process based on the changing proposal when the switching timing to the changing proposal is reached before the operation of the process in which the delay is detected is ended (for example, step 1105).

With this, the production plan can be switched to the changing proposal when the switching timing to the changing proposal is reached.
(9) A production execution system has the progress management system described in the above (8) and a production control unit connected to the progress management system (for example, the production implementation unit 150). The production control unit controls the equipment so as to execute the operation of the process based on the changing proposal when the switching timing to the changing proposal is reached before the operation of the process in which the delay is detected is ended.

With this, even when the delay of the process occurs, the operation of the process can be controlled so as not to lower the productivity.

The present invention is not limited to the above-described embodiments, and further includes various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

In addition, the above respective configurations, functions, processing units, processing means, and the like may be achieved by hardware by, for example, designing part or all of them by, for example, an integrated circuit. In addition, the above respective configurations, functions, and the like may be achieved by software with the processor interpreting and executing the program achieving the respective functions. The information on the program, the table, the file, and the like achieving each function can be stored in a storage device, such as a nonvolatile semiconductor memory, a hard disk drive, and an SSD (Solid State Drive), or a calculator-readable non-transitory data storage medium, such as an IC card, an SD card, and a DVD.

In addition, any control lines and information lines that are considered to be required for the description are represented, and for the product, all the control lines and information lines are not always represented. It may be considered that actually, almost all of the configurations are mutually connected.

1. A progress management system comprising:
a control unit; and
a storage unit, wherein
the storage unit holds a production plan for one or more products,
the production plan includes, for the operation of each process for producing each of the products, the allocation of the operation of the process to equipment, a scheduled start time for the operation of the process, and a scheduled end time for the operation of the process,
the control unit predicts, on the basis of the production plan, productivity for the case in which the operation of the process is delayed, and
on the basis of the delay amount of the operation of the process for the case in which it is predicted that the productivity will not satisfy a predetermined standard, the control unit generates a changing proposal for the production plan and a switching timing to the changing proposal for the production plan such that the productivity satisfies the predetermined standard when the delay of the delay amount occurs in the operation of the process.

2. The progress management system according to claim 1, wherein
the control unit generates the changing proposal changing at least one of the allocation to the equipment or the scheduled start time of, among the operations of the processes included in the production plan, at least one of the operations of the processes in which the scheduled start time is later than the scheduled end time of the operation of the process for the case in which the delay in which it is predicted that the productivity will not satisfy the predetermined standard occurs.

3. The progress management system according to claim 2, wherein
the storage unit further holds, for each combination of the article of the product and the process, a production preparation manhour that is a manhour necessary for preparation starting the operation of the process, and
the control unit calculates a time starting preparation on the basis of the production preparation manhour for the operation of each of the processes changed in the changing proposal, and generates, as the switching timing, the earliest time among the calculated times.

4. The progress management system according to claim 1, wherein
the control unit predicts that the productivity will not satisfy the predetermined standard when it is predicted that the delivery date of any one of the products will be delayed.

5. The progress management system according to claim 1, wherein
the control unit predicts that the productivity will not satisfy the predetermined standard when it is predicted that the operation rate of the equipment will become lower than the predetermined standard.

6. The progress management system according to claim 1, wherein
the control unit generates the changing proposal for the production plan and the switching timing to the changing proposal for the production plan before the operation of the process based on the production plan is started.

7. The progress management system according to claim 1, wherein
the control unit acquires the result of the operation of each of the processes after the operation of the process based on the production plan is started, and
when detecting, on the basis of the acquired result and the production plan, the delay of the operation of any one of the processes, the control unit outputs an instruction to stop the preparation of the operation of the process started after that point in time.

8. The progress management system according to claim 7, wherein
the control unit outputs the instruction of the operation of the process based on the changing proposal when the switching timing to the changing proposal is reached before the operation of the process in which the delay is detected is ended.

9. A production execution system that has the progress management system according to claim 8 and a production control unit connected to the progress management system, wherein
the production control unit controls the equipment so as to execute the operation of the process based on the changing proposal when the switching timing to the changing proposal is reached before the operation of the process in which the delay is detected is ended.

10. A progress management method that is executed by a progress management system, the progress management system having a control unit and a storage unit, wherein
the storage unit holds a production plan for one or more products,
the production plan includes, for the operation of each process for producing each of the products, allocation of the operation of the process to equipment, a scheduled start time for the operation of the process, and a scheduled end time for the operation of the process, and
the progress management method includes:
a procedure of allowing the control unit to predict, on the basis of the production plan, productivity for the case in which the operation of the process is delayed; and
a procedure of allowing the control unit to, on the basis of the delay amount of the operation of the process for the case in which it is predicted that the productivity will not satisfy a predetermined standard, generates a changing proposal for the production plan and a switching timing to the changing proposal for the production plan such that the productivity satisfies the predetermined standard when the delay of the delay amount occurs in the operation of the process.
